(19) United States
(12) Patent Application Publication
(10) Pub. No.: US 2023/0220182 A1
(43) Pub. Date: Jul. 13, 2023

(54) High Performance Polymer Composition Containing Carbon Nanostructures

(71) Applicant: Ticona LLC, Florence, KY (US)

(72) Inventor: Young Shin Kim, Cincinnati, OH (US)

(21) Appl. No.: 18/093,847

(22) Filed: Jan. 6, 2023

Related U.S. Application Data
(60) Provisional application No. 63/327,442, filed on Apr. 5, 2022.
(60) Provisional application No. 63/299,122, filed on Jan. 13, 2022.

(51) Int. Cl. C08K 3/04; C09K 19/38; C08G 63/60; C08G 75/14; C08G 65/40; C08K 7/06; C08K 7/14; C08G 77/04; B29C 48/00; B29C 48/395

(52) U.S. Cl. CPC C08K 3/041; C09K 19/3809; C08G 63/605; C08G 75/14; C08G 65/4012; C08K 7/06; C08K 7/14; C08G 77/04; B29C 48/022; B29C 48/397; C08G 2650/40; C08K 2201/001; B29K 2105/0079

(57) ABSTRACT

A polymer composition comprising carbon nanostructures dispersed within a polymer matrix that includes a thermoplastic polymer having a deflection temperature under load of about 40° C. or more as determined in accordance with ISO 75:2013 at a load of 1.8 MPa and a melting temperature of about 140° C. or more is provided. The carbon nanostructures include carbon nanotubes that are arranged in a network having a web-like morphology and optionally disposed on a substrate.

### RELATED APPLICATIONS

The present application is based upon and claims priority to U.S. Provisional Patent Application Ser. No. 63/299,122 having a filing date of Jan. 13, 2022 and U.S. Provisional Patent Application Ser. No. 63/327,442, having a filing date of Apr. 5, 2022, which are incorporated herein by reference.

### BACKGROUND OF THE INVENTION

Electronic components (e.g., printed circuit board, antenna elements, radio frequency devices, sensors, light sensing and/or transmitting elements (e.g., fibers optics), camera modules, global positioning devices, etc.) generally contain polymeric materials for a variety of different purposes. In some cases, it is desired that these compositions have some degree of electrical conductivity. A radar device, for instance, typically contains one or more printed circuit boards having electrical components dedicated to handling radio frequency (RF) radar signals, digital signal processing tasks, etc. To ensure that these components operate effectively at high frequencies, they are generally received in a housing structure and then covered with a radome that is transparent to radio waves. Because other surrounding electrical devices can generate electromagnetic interference (“EMI”) that can impact the accurate operation of the radar device, it is often desirable to employ a polymer material in the radar device that has a sufficient degree of electrical conductivity such that it can provide EMI shielding. Likewise, camera modules are often employed in mobile phones, laptop computers, digital cameras, digital video cameras, etc. Because friction between molded parts can induce electrostatic charge, which can lead to the formation of dust particles (e.g., during transportation) if not handled properly, it is often desirable to employ a polymer material in the camera module that has a sufficient degree of electrical conductivity such that it can provide electrostatic discharge. While various electrically conductive polymer materials have been attempted for use in these applications, it is often difficult to achieve the desired degree of electrical conductivity without adversely impacting other properties of the composition, particularly when high performance polymers are employed.

As such, a need currently exists for an improved high performance polymer composition that can exhibit a certain degree of electrical conductivity.

### SUMMARY OF THE INVENTION

In accordance with one embodiment of the present invention, a polymer composition is disclosed that comprises carbon nanostructures dispersed within a polymer matrix that includes a thermoplastic polymer having a deflection temperature under load of about 40° C. or more as determined in accordance with ISO 75:2013 at a load of 1.8 MPa and a melting temperature of about 140° C. or more. The carbon nanostructures include carbon nanotubes that are arranged in a network having a web-like morphology and optionally disposed on a substrate.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIGS. 1A-1C show illustrative depictions of certain embodiments of carbon nanotubes that may be employed in the present invention;

FIG. 2 shows an illustrative depiction of a carbon nanostructure flake material that may be employed in the polymer composition of the present invention;

FIG. 3 shows an SEM image of an illustrative carbon nanostructure that may be employed in the polymer composition of the present invention;

FIG. 4 is a schematic exploded perspective view of a radar device that may employ the polymer composition of the present invention;

FIG. 5 is a perspective view of a camera module that may be formed in accordance with one embodiment of the present invention;

FIG. 6 is a top perspective view of one embodiment of an electronic device containing the camera module of the present invention; and

FIG. 7 is a bottom perspective view of the electronic device shown in FIG. 6.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition containing carbon nanostructures dispersed within a polymer matrix that includes a thermoplastic polymer having a deflection temperature under load of about 40° C. or more as determined in accordance with ISO 75:2013 at a load of 1.8 MPa and a melting temperature of about 140° C. or more. The carbon nanostructures include carbon nanotubes that are optionally disposed on a substrate and arranged in a network having a web-like morphology. By selectively controlling the particular components of the composition and their relative concentration, it has been discovered that the resulting composition may exhibit unique properties for use in a wide variety of possible product applications, such as electronic devices (e.g., radar devices) and other applications requiring electrically conductive polymer materials. The surface resistivity may, for instance, be about 1×10¹² ohms or less, in some embodiments about 1×10¹⁰ ohms or less, in some embodiments about 1×10⁷ ohms or less, and in some embodiments, from about 1×10³ to about 1×10⁶ ohms, such as determined at a temperature of about 20° C. in accordance with IEC 62631-3-2:2016. The volume resistivity may likewise be about 1×10⁷ ohm-m or less, in some embodiments about 1×10⁶ ohm-m or less, in some embodiments about 1×10⁵ ohm-m or less, and in some embodiments, from about 1×10² to about 1×10⁴ ohm-m, such as determined at a temperature of about 20° C. in accordance with IEC 62631-3-1:2016.

In certain embodiments, for example, the polymer composition may exhibit an EMI shielding effectiveness (“SE”) of about 40 decibels (dB) or more, in some embodiments about 45 dB or more, in some embodiments about 50 dB or more, and in some embodiments, from about 55 dB to about 200 dB, as determined in accordance with ASTM D4935-18 at a high frequency, such as 6 GHz. The EMI shielding effectiveness may remain stable over a high frequency range, such as about 700 MHz or more, in some embodiments from about 1 GHz to about 100 GHz, and in some embodiments, from about 2 GHz to about 18 GHz. The EMI shielding effectiveness may also be within the desired range for a variety of different part thicknesses, such as from about 0.5 to about 10 millimeters, in some embodiments from about 0.8 to about 5 millimeters, and in some embodiments, from about 1 to about 4 millimeters (e.g., 1 millimeter, 1.6 millimeters, or 3 millimeters). Within these high frequency and/or thickness ranges, for example, the average EMI shielding effectiveness may be about 40 dB or more, in some embodiments about 45 dB or more, and in some embodiments, from about 50 dB to about 200 dB. Likewise, the minimum EMI shielding effectiveness may be about 10 dB or more, in some embodiments about 15 dB or more, and in some embodiments, from about 20 dB to about 100 dB. The composition may also have good EMI shielding effectiveness at lower frequencies, such as from 200 MHz to 1.5 GHz. For example, within these lower frequency ranges and the thickness ranges noted above, the average EMI shielding effectiveness may be about 50 dB or more, in some embodiments about 55 dB or more, and in some embodiments, from about 60 dB to about 200 dB.

Conventionally, it was believed that polymer compositions exhibiting good electrical conductivity and/or EMI shielding effectiveness would not also possess sufficient mechanical properties for use in certain types of devices. It has been discovered, however, that the polymer composition is still able to maintain excellent mechanical properties. For example, the polymer composition may exhibit a Charpy notched impact strength of about 2 kJ/m² or more, in some embodiments from about 4 to about 50 kJ/m², and in some embodiments, from about 6 to about 30 kJ/m², measured at according to ISO Test No. 179-1:2010 (technically equivalent to ASTM D6110) at various temperatures, such as within a temperature range of from about −50° C. to about 85° C. (e.g., 23° C.). The tensile and flexural mechanical properties may also be good. For example, the polymer composition may exhibit a tensile strength of about 50 MPa or more, in some embodiments from about 80 MPa or more, and in some embodiments, from about 100 to about 200 MPa; a tensile break strain of about 0.1% or more, in some embodiments from about 0.5% to about 5%, and in some embodiments, from about 0.8% to about 2.5%; and/or a tensile modulus of from about 5,000 MPa to about 50,000 MPa, in some embodiments from about 10,000 MPa to about 40,000 MPa, and in some embodiments, from about 15,000 MPa to about 35,000 MPa. The tensile properties may be determined in accordance with ISO Test No. 527-1:2019 (technically equivalent to ASTM D638-14) at various temperatures, such as within a temperature range of from about −50° C. to about 85° C. (e.g., 23° C.). The polymer composition may also exhibit a flexural strength of from about 100 to about 600 MPa, in some embodiments from about 120 to about 500 MPa, and in some embodiments, from about 150 to about 400 MPa; a flexural break strain of about 0.5% or more, in some embodiments from about 0.8% to about 5%, and in some embodiments, from about 1.0% to about 2.5%; and/or a flexural modulus of from about 5,000 MPa to about 60,000 MPa, in some embodiments from about 10,000 MPa to about 55,000 MPa, and in some embodiments, from about 15,000 MPa to about 40,000 MPa. The flexural properties may be determined in accordance with ISO Test No. 178:2019 (technically equivalent to ASTM D790-17) at various temperatures, such as within a temperature range of from about −50° C. to about 85° C. (e.g., 23° C.).

The composition may also possess good thermal properties. For example, the polymer composition may exhibit a deflection temperature under load (DTUL) of about 150° C. or more, in some embodiments about 200° C. and in some embodiments, from about 250° C. to about 300° C., as determined in accordance with ISO 75:2013 (technically equivalent to ASTM D648-07) at a specified load of 1.8 MPa. The polymer composition can also be thermally conductive and thus, for example, exhibit an in-plane thermal conductivity of about 1 W/m-K or more, in some embodiments about 1.5 W/m-K or more, and in some embodiments, from about 2 to about 10 W/m-K, as determined in accordance with ASTM E 1461-13. The composition may also exhibit a through-plane thermal conductivity of about 0.3 W/m-K or more, in some embodiments about 0.4 W/m-K or more, in some embodiments about 0.5 W/m-K or more, and in some embodiments, from about 0.7 to about 3 W/m-K, as determined in accordance with ASTM E 1461-13. The melt viscosity of the polymer composition may also be very low, such as from about 0.1 to about 150 Pa-s, in some embodiments from about 0.2 to about 100 Pa-s, in some embodiments from about 0.5 to about 80 Pa-s, and in some embodiments, from about 1 to about 50 Pa-s, determined at a shear rate of 1,000 seconds⁻¹ and temperature of about 15° C. greater than the melting temperature of the polymer composition in accordance with ISO 11443:2021.

Various embodiments of the present invention will now be described in more detail.

### I. Polymer Matrix

A. Thermoplastic Polymers

As noted, the polymer matrix may contain one or more thermoplastic polymers. Typically, it is desired that such polymers have a high degree of heat resistance, such as reflected by a deflection temperature under load (“DTUL”) of about 40° C. or more, in some embodiments about 50° C. or more, in some embodiments about 60° C. or more, in some embodiments from about from about 80° C. to about 250° C., and in some embodiments, from about 100° C. to about 200° C., as determined in accordance with ISO 75:2013 at a load of 1.8 MPa. The thermoplastic polymers are also semi-crystalline or crystalline in nature and exhibit a high melting temperature, such as about 140° C. or more, in some embodiments from about 150° C. to about 400° C., and in some embodiments, from about 200° C. to about 380° C. The melting temperature may be determined using differential scanning calorimetry (“DSC”) in accordance with ISO 11357-3:2018. Of course, in addition to exhibiting a high degree of heat resistance and a high melting temperature, the thermoplastic polymers may also exhibit a high glass transition temperature, such as about 10° C. or more, in some embodiments about 20° C. or more, in some embodiments about 30° C. or more, in some embodiments about 40° C. or more, in some embodiments about 50° C. or more, and in some embodiments, from about 60° C. to about 320° C. The glass transition temperature may be determined using differential scanning calorimetry in accordance with ISO 11357-2:2020.

Suitable thermoplastic polymers for this purpose may include, for instance, polyolefins (e.g., ethylene polymers, propylene polymers, etc.), polyamides (e.g., aliphatic, semi-aromatic, or aromatic polyamides), polyesters, polyarylene sulfides, liquid crystalline polymers (e.g., wholly aromatic polyesters, polyesteramides, etc.), polyethers (e.g., polyoxymethylene), polyaryletherketones, etc., as well as blends thereof. The exact choice of the polymer system will depend upon a variety of factors, such as the nature of other fillers included within the composition, the manner in which the composition is formed and/or processed, and the specific requirements of the intended application.

Aromatic polymers, for instance, are particularly suitable in some applications. One example of a suitable semi-crystalline aromatic polymer, for instance, is an aromatic polyester, which may be a condensation product of at least one diol (e.g., aliphatic and/or cycloaliphatic) with at least one aromatic dicarboxylic acid, such as those having from 4 to 20 carbon atoms, and in some embodiments, from 8 to 14 carbon atoms. Suitable diols may include, for instance, neopentyl glycol, cyclohexanedimethanol, 2,2-dimethyl-1,3-propane diol and aliphatic glycols of the formula HO(CH₂)ₙOH where n is an integer of 2 to 10. Suitable aromatic dicarboxylic acids may include, for instance, isophthalic acid, terephthalic acid, 1,2-di(p-carboxyphenyl)ethane, 4,4′-dicarboxydiphenyl ether, etc., as well as combinations thereof. Fused rings can also be present such as in 1,4- or 1,5- or 2,6-naphthalene-dicarboxylic acids. Particular examples of such aromatic polyesters may include, for instance, poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), as well as mixtures of the foregoing.

Derivatives and/or copolymers of aromatic polyesters (e.g., polyethylene terephthalate) may also be employed. For instance, in one embodiment, a modifying acid and/or diol may be used to form a derivative of such polymers. As used herein, the terms “modifying acid” and “modifying diol” are meant to define compounds that can form part of the acid and diol repeat units of a polyester, respectively, and which can modify a polyester to reduce its crystallinity. Examples of modifying acid components may include, but are not limited to, isophthalic acid, phthalic acid, 1,3-cyclohexanedicarboxylic acid, 1,4-cyclohexane dicarboxylic acid, 2,6-naphthaline dicarboxylic acid, succinic acid, glutaric acid, adipic acid, sebacic acid, suberic acid, 1,12-dodecanedioic acid, etc. In practice, it is often preferable to use a functional acid derivative thereof such as the dimethyl, diethyl, or dipropyl ester of the dicarboxylic acid. The anhydrides or acid halides of these acids also may be employed where practical. Examples of modifying diol components may include, but are not limited to, neopentyl glycol, 1,4-cyclohexanedimethanol, 1,2-propanediol, 1,3-propanediol, 2-methy-1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl 1,3-cyclobutane diol, Z,8-bis(hydroxymethyltricyclo-[5.2.1.0]-decane wherein Z represents 3, 4, or 5; 1,4-bis(2-hydroxyethoxy)benzene, 4,4′-bis(2-hydroxyethoxy) diphenylether [bis-hydroxyethyl bisphenol A], 4,4′-Bis(2-hydroxyethoxy)diphenylsulfide [bis-hydroxyethyl bisphenol S] and diols containing one or more oxygen atoms in the chain, e.g., diethylene glycol, triethylene glycol, dipropylene glycol, tripropylene glycol, etc. In general, these diols contain 2 to 18, and in some embodiments, 2 to 8 carbon atoms. Cycloaliphatic diols can be employed in their cis- or trans-configuration or as mixtures of both forms.

The aromatic polyesters, such as described above, typically have a DTUL value of from about 40° C. to about 80° C., in some embodiments from about 45° C. to about 75° C., and in some embodiments, from about 50° C. to about 70° C. as determined in accordance with ISO 75:2013 at a load of 1.8 MPa. The aromatic polyesters likewise typically have a glass transition temperature of from about 30° C. to about 120° C., in some embodiments from about 40° C. to about 110° C., and in some embodiments, from about 50° C. to about 100° C., as well as a melting temperature of from about 170° C. to about 300° C., in some embodiments from about 190° C. to about 280° C., and in some embodiments, from about 210° C. to about 260° C. The aromatic polyesters may also have an intrinsic viscosity of from about 0.1 dl/g to about 6 dl/g, in some embodiments from about 0.2 to about 5 dl/g, and in some embodiments from about 0.3 to about 1 dl/g, such as determined in accordance with ISO 1628-5:1998.

Polyarylene sulfides are also suitable semi-crystalline aromatic polymers. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

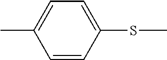

and segments having the structure of formula:

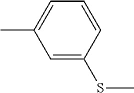

or segments having the structure of formula:

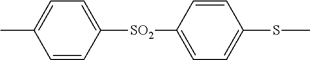

The polyarylene sulfide may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

The polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

Another suitable semi-crystalline aromatic polymer that may be employed in the present invention is a polyaryletherketone. Polyaryletherketones are semi-crystalline polymers with a relatively high melting temperature, such as from about 300° C. to about 400° C., in some embodiments from about 310° C. to about 390° C., and in some embodiments, from about 330° C. to about 380° C. The glass transition temperature may likewise be from about 110° C. to about 200° C. Particularly suitable polyaryletherketones are those that primarily include phenyl moieties in conjunction with ketone and/or ether moieties. Examples of such polymers include polyetheretherketone (“PEEK”), polyetherketone (“PEK”), polyetherketoneketone (“PEKK”), polyetherketoneetherketoneketone (“PEKEKK”), polyetheretherketoneketone (“PEEKK”), polyether-diphenyl-ether-ether-diphenyl-ether-phenyl-ketone-phenyl, etc., as well as blends and copolymers thereof.

In addition to the polymers referenced above, highly crystalline aromatic polymers may also be employed in the polymer composition. Particularly suitable examples of such polymers are liquid crystalline polymers, which have a high degree of crystallinity that enables them to effectively fill the small spaces of a mold. Liquid crystalline polymers are generally classified as “thermotropic” to the extent that they can possess a rod-like structure and exhibit a crystalline behavior in their molten state (e.g., thermotropic nematic state). Such polymers typically have a DTUL value of from about 120° C. to about 340° C., in some embodiments from about 140° C. to about 320° C., and in some embodiments, from about 150° C. to about 300° C., as determined in accordance with ISO 75:2013 at a load of 1.8 MPa. The polymers also have a relatively high melting temperature, such as from about 250° C. to about 400° C., in some embodiments from about 280° C. to about 390° C., and in some embodiments, from about 300° C. to about 380° C. Such polymers may be formed from one or more types of repeating units as is known in the art.

A liquid crystalline polymer may, for example, contain one or more aromatic ester repeating units, typically in an amount of from about 60 mol. % to 100 mol. %, in some embodiments from about 70 mol. % to about 99.5 mol. %, and in some embodiments, from about 80 mol. % to about 99 mol. % of the polymer. The aromatic ester repeating units may be generally represented by the following Formula (V):

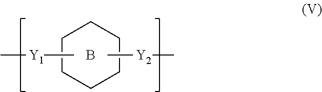

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula V are C(O)), aromatic hydroxycarboxylic repeating units (Y₁ is O and Y₂ is C(O) in Formula V), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 5 mol. % to about 60 mol. %, in some embodiments from about 10 mol. % to about 50 mol. %, and in some embodiments, from about 20 mol. % to about 40 mol. % of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 10 mol. % to about 75 mol. %, in some embodiments from about 20 mol. % to about 60 mol. %, and in some embodiments, from about 30 mol. % to about 50 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 50 mol. %, in some embodiments from about 5 mol. % to about 45 mol. %, and in some embodiments, from about 10 mol. % to about 40 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In one particular embodiment, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, and in some embodiments, from about 18 mol. % to about 35 mol. % of the polymer. In one embodiment, for instance, the repeating units derived from NDA may constitute 10 mol. % or more, in some embodiments about 12 mol. % or more, in some embodiments about 15 mol. % or more, and in some embodiments, from about 18 mol. % to about 35 mol. % of the polymer. When employed, the molar ratio of repeating units derived from HBA to the repeating units derived from naphthenic units (e.g., NDA, HNA, or both) may be selectively controlled within a specific range to help achieve the desired properties, such as from about 1 to about 20, in some embodiments from about 1.5 to about 15, and in some embodiments, from about 2 to about 10. The polymer may also contain repeating units derived from aromatic dicarboxylic acid(s) (e.g., IA and/or TA) in an amount of from about 1 mol. % to about 20 mol. %, and in some embodiments, from about 2 mol. % to about 15 mol. %; and/or aromatic diol(s) (e.g., BP and/or HQ) in an amount of from about 20 mol. % to about 50 mol. %, and in some embodiments, from about 30 mol. % to about 45 mol. %. In some cases, however, it may be desired to minimize the presence of such monomers in the polymer to help achieve the desired properties. For example, the total amount of repeating units derived from aromatic dicarboxylic acid(s) (e.g., IA and/or TA) and/or aromatic diols (e.g., BP and/or HQ) may be about 5 mol % or less, in some embodiments about 4 mol. % or less, and in some embodiments, from about 0.1 mol. % to about 3 mol. %, of the polymer.

In certain embodiments, all of the liquid crystalline polymers are “high naphthenic” polymers such as described above. In other embodiments, however, “low naphthenic” liquid crystalline polymers may also be employed in the composition in which the total amount of repeating units derived from naphthenic hydroxycarboxylic and/or dicarboxylic acids (e.g., NDA, HNA, or a combination of HNA and NDA) is less than 10 mol. %, in some embodiments about 8 mol. % or less, in some embodiments about 6 mol. % or less, and in some embodiments, from about 1 mol. % to about 5 mol. % of the polymer. When employed, it is generally desired that such low naphthenic polymers are present in only a relatively low amount. For example, when employed, low naphthenic liquid crystalline polymers typically constitute from about 1 wt. % to about 50 wt. %, in some embodiments from about 10 wt. % to about 45 wt. %, and in some embodiments, from about 15 wt. % to about 40 wt. % of the total amount of liquid crystalline polymers in the composition, and from about 0.5 wt. % to about 45 wt. %, in some embodiments from about 2 wt. % to about 35 wt. %, and in some embodiments, from about 5 wt. % to about 25 wt. % of the entire composition. Conversely, high naphthenic liquid crystalline polymers typically constitute from about 50 wt. % to about 99 wt. %, in some embodiments from about 55 wt. % to about 95 wt. %, and in some embodiments, from about 60 wt. % to about 85 wt. % of the total amount of liquid crystalline polymers in the composition, and from about 25 wt. % to about 65 wt. %, in some embodiments from about 30 wt. % to about 60 wt. %, and in some embodiments, from about 35 wt. % to about 55 wt. % of the entire composition.

Of course, besides aromatic polymers, aliphatic polymers may also be suitable for use as high performance, thermoplastic polymers in the polymer matrix. In one embodiment, for instance, polyamides may be employed that generally have a CO—NH linkage in the main chain and are obtained by condensation of an aliphatic diamine and an aliphatic dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Aliphatic dicarboxylic acids may include, for instance, adipic acid, sebacic acid, etc. Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable.

It should be understood that it is also possible to include aromatic monomer units in the polyamide such that it is considered aromatic (contains only aromatic monomer units are both aliphatic and aromatic monomer units). Examples of aromatic dicarboxylic acids may include, for instance, terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc. Particularly suitable aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

Suitable polyamides for the polymer matrix are typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C.

Propylene polymers may also be suitable aliphatic high performance polymers for use in the polymer matrix. Any of a variety of propylene polymers or combinations of propylene polymers may generally be employed in the polymer matrix, such as propylene homopolymers (e.g., syndiotactic, atactic, isotactic, etc.), propylene copolymers, and so forth. In one embodiment, for instance, a propylene polymer may be employed that is an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. In yet other embodiments, a copolymer of propylene with an α-olefin monomer may be employed. Specific examples of suitable α-olefin monomers may include ethylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. The propylene content of such copolymers may be from about 60 mol. % to about 99 mol. %, in some embodiments from about 80 mol. % to about 98.5 mol. %, and in some embodiments, from about 87 mol. % to about 97.5 mol. %. The α-olefin content may likewise range from about 1 mol. % to about 40 mol. %, in some embodiments from about 1.5 mol. % to about 15 mol. %, and in some embodiments, from about 2.5 mol. % to about 13 mol. %.

Suitable propylene polymers are typically those having a DTUL value of from about 80° C. to about 250° C., in some embodiments from about 100° C. to about 220° C., and in some embodiments, from about 110° C. to about 200° C., as determined in accordance with ISO 75:2013 at a load of 1.8 MPa. The glass transition temperature of such polymers may likewise be from about 10° C. to about 80° C., in some embodiments from about 15° C. to about 70° C., and in some embodiments, from about 20° C. to about 60° C. Further, the melting temperature of such polymers may be from about 50° C. to about 250° C., in some embodiments from about 90° C. to about 220° C., and in some embodiments, from about 100° C. to about 200° C.

Oxymethylene polymers may also be suitable aliphatic high performance polymers for use in the polymer matrix. Oxymethylene polymers can be either one or more homopolymers, copolymers, or a mixture thereof. Homopolymers are prepared by polymerizing formaldehyde or formaldehyde equivalents, such as cyclic oligomers of formaldehyde. Copolymers can contain one or more comonomers generally used in preparing polyoxymethylene compositions. Commonly used comonomers include alkylene oxides of 2-12 carbon atoms. If a copolymer is selected, the quantity of comonomer will typically not be more than 20 weight percent, in some embodiments not more than 15 weight percent, and, in some embodiments, about two weight percent. Comonomers can include ethylene oxide and butylene oxide. It is preferred that the homo- and copolymers are: 1) those whose terminal hydroxy groups are end-capped by a chemical reaction to form ester or ether groups; or, 2) copolymers that are not completely end-capped, but that have some free hydroxy ends from the comonomer unit. Typical end groups, in either case, are acetate and methoxy.

B. Carbon Nanostructures

As indicated above, carbon nanostructures are also distributed within the polymer matrix. The carbon nanostructures are typically employed in an amount of from about 0.1 parts to about 10 parts by weight, in some embodiments from about 0.2 parts to about 6 parts by weight, and in some embodiments, from about 0.5 parts to about 2.5 parts by weight per 100 parts by weight of the polymer matrix. For example, the carbon nanostructures may constitute from about 0.1 wt. % to about 5 wt. %, in some embodiments from about 0.2 wt. % to about 3 wt. %, and in some embodiments, from about 0.4 wt. % to about 1.5 wt. % of the polymer composition. The polymer matrix may, in certain embodiments, constitute from about 1 wt. % to about 90 wt. %, in some embodiments from about 5 wt. % to about 80 wt. %, in some embodiments from about 10 wt. % to about 70 wt. %, in some embodiments from about 20 wt. % to about 60 wt. %, and in some embodiments, from about 30 wt. % to about 50 wt. % of the polymer composition.

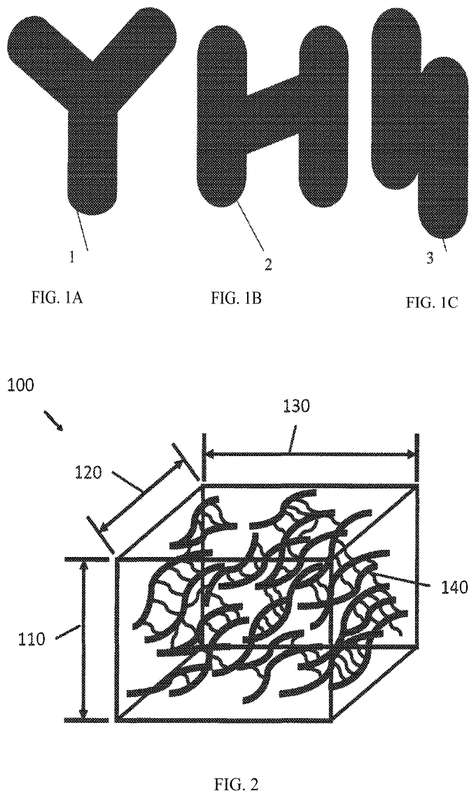

The carbon nanostructures generally include carbon nanotubes that are optionally disposed on a substrate and arranged in a network having a web-like morphology in that at least a portion of the carbon nanotubes are branched, crosslinked, interdigitated, share common walls with one another, and so forth. It should be understood that every carbon nanotube does not necessarily have the foregoing structural features. Rather, the carbon nanotubes as a whole can possess one or more of these structural features. For example, in some embodiments, a portion of the carbon nanotubes may be branched, another portion of the carbon nanotubes may be crosslinked, and yet another portion of the carbon nanotubes may share common walls. Likewise, in some embodiments, at least a portion of the carbon nanotubes can be interdigitated with one another and/or with branched, crosslinked, or common-wall carbon nanotubes in the remainder of the carbon nanostructure. FIGS. 1A-1C show illustrative depictions of carbon nanotubes 1-3 that are branched, crosslinked, and share common walls, respectively.

The web-like morphology of the carbon nanostructure can result in a low bulk density. For example, as-produced carbon nanostructures can have an initial bulk density ranging between about 0.003 g/cm³ to about 0.015 g/cm³. Further consolidation and/or coating to produce a flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further altered by forming a coating on the carbon nanotubes and/or infiltrating the interior of the carbon nanostructure with various materials. Coating the carbon nanotubes and/or infiltrating the interior of the carbon nanostructure can further tailor the properties of the carbon nanostructure for use in various applications. Moreover, in some embodiments, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

Various techniques may be employed to form the carbon nanostructures. In one embodiment, for instance, carbon nanotubes may be formed (e.g., grown, infused, etc.) on a substrate. Depending on the desired form of the nanostructures, the carbon nanotubes may be separated from the substrate or remain thereon. Examples of techniques for growing the nanotubes on a substrate are described, for example, in U.S. Patent Application Publication No. 2014/0093728, as well as U.S. Pat. Nos. 8,784,937; 9,005,755; 9,107,292; 9,241,433; and 9,447,259, all of which are incorporated herein in their entirety by reference thereto. Without intending to be limited by theory, it is believed that the use of a substrate can help form the complex, web-like morphology due to the ability of carbon nanotubes to grow at a rapid rate, such as on the order of several micrometers per second. The rapid carbon nanotube growth rate, coupled with the close proximity of the carbon nanotubes to one another, can confer the observed branching, crosslinking, and shared wall motifs to the carbon nanotubes.

Any of a variety of substrates may be employed during the synthesis of the carbon nanostructures, such as glass, inorganic materials, carbon materials, metals, polymers, etc. In some embodiments, the substrate can be a fiber material of a spoolable dimension (e.g., fabric, tow, fibers, yarn, sheet, tape, belt, etc.), which allows the formation of the carbon nanotubes to take place continuously on the substrate as it is conveyed from a first location to a second location. Such fiber materials may also provide additional functional benefits to the polymer composition when they remain attached to the carbon nanotube structure, such as enhancing strength and/or improving electrical conductivity. As used herein, the term “spoolable dimension” generally refers to fiber materials having at least one dimension that is not limited in length, allowing for the material to be stored on a spool or mandrel. Suitable fiber materials may, for instance, include materials made from glass (e.g., E-glass, S-glass, D-glass, etc.), carbon (e.g., graphite), ceramic, polymeric materials (e.g., polyamide, aramid, polyester, etc.), metals (e.g., steel, aluminum, copper, tungsten, etc.), carbides (e.g., silicon carbide), cellulosic materials, etc., as well as combinations thereof. Carbon fiber materials may, for instance, be suitable, particularly when it is desired to further increase the electrical conductivity of the polymer composition. When such fibers are employed as the substrate, the carbon nanotubes may be infused into the fibers. For example, the carbon nanotubes may be grown generally perpendicularly from the outer surface of fibers, thereby providing a radial coverage to each individual fiber. Carbon nanotubes may be grown in situ on fibers. For example, a fiber may be fed through a growth chamber maintained at a given temperature of about 500° C. to about 750° C. Carbon containing feed gas can then be introduced into the growth chamber, wherein carbon radicals dissociate and initiate formation of carbon nanotubes on the fiber.

Regardless of the nature of the substrate, a catalyst is typically employed to help ensure the formation of the carbon nanostructures. Particularly suitable catalysts include, for instance, transition metal nanoparticles. Suitable transition metal nanoparticle catalysts can include any d-block transition metal or d-block transition metal salt. Non-limiting exemplary transition metal nanoparticles may include nickel, iron, cobalt, molybdenum, copper, platinum, gold, silver, etc., as well as salts and mixtures thereof. One mode for applying the catalyst to the substrate (e.g., infusion) can be through particle adsorption, such as through a liquid or colloidal catalyst solution. For example, a catalyst solution may be employed that contains the nanoparticles that include a transition metal or a salt thereof, such as an acetate, carbide, etc. In such embodiments, the transition metal salt can be converted into a zero-valent transition metal on the substrate through a thermal treatment. The transition metal nanoparticles may also be coated with an anti-adhesive coating that limits their adherence to the substrate and promote removal of the carbon nanostructure from the substrate following synthesis of the carbon nanostructure. In some embodiments, the carbon nanostructure can be removed from the substrate without substantially removing the transition metal nanoparticle catalyst.

As noted above, the carbon nanotube structure may optionally be removed from the substrate. In such embodiments, known techniques may be employed for the removal of the carbon nanotubes, such as providing an anti-adhesive coating on the substrate, providing an anti-adhesive coating on a transition metal nanoparticle catalyst employed in synthesizing the carbon nanostructure, providing a transition metal nanoparticle catalyst with a counter ion that etches the substrate, thereby weakening the adherence of the carbon nanostructure to the substrate, and/or conducting an etching operation after carbon nanostructure synthesis is complete to weaken adherence of the carbon nanostructure to the substrate. In one embodiment, for instance, a high pressure liquid or gas may be employed to separate the carbon nanostructures from the substrate. Thereafter, contaminants derived from the substrate (e.g., fragmented substrate) may be separated from the carbon nanostructures, such as by using cyclone filtering, density separation, size-based separation, etc. The nanostructures may then be collected with air or from a liquid medium with the aid of a filter medium, and thereafter isolated from the filter medium. Of course, in other embodiments, the carbon nanostructures are not removed from the substrate. This may be particularly desirable when the substrate itself can provide other functional benefits to the polymer composition.

In some embodiments, at least a portion of the carbon nanotubes can be aligned substantially parallel to one another in the carbon nanostructure. Without being bound by any theory, it is believed that the formation of carbon nanotubes on a substrate under the carbon nanostructure growth conditions described herein results in substantially vertical growth of at least a majority of the carbon nanotubes from the substrate surface. Even after any optional removal of the carbon nanostructure from the substrate, the substantially parallel alignment of the carbon nanotubes can be maintained. In fact, the structural features of branching, crosslinking, and shared carbon nanotube walls can sometimes become more prevalent at locations on the carbon nanotubes that are further removed from the substrate. Regardless, because the carbon nanostructures can be obtained with the carbon nanotubes aligned substantially parallel with respect to one another, they can be manipulated more readily with respect to alignment than can individual carbon nanotubes, which may need to undergo further processing to bring the carbon nanotubes into parallel alignment. Parallel alignment of carbon nanotubes can improve electrical conductivity and enhance mechanical strength in the direction of carbon nanotube alignment.

A coating may also be applied to the carbon nanotubes of the carbon nanostructure before or after removal of the carbon nanostructure from the substrate. Application of a coating before removal of the carbon nanostructure from the substrate can, for example, protect the carbon nanotubes during the removal process or facilitate the removal process. In other embodiments, a coating can be applied to the carbon nanotubes of the carbon nanostructure after removal of the carbon nanostructure from the substrate. Application of a coating to the carbon nanotubes of the carbon nanostructure after its removal from the substrate can desirably facilitate handling and storage of the carbon nanostructure. In particular, coating the carbon nanostructure can desirably promote the consolidation or densification of the carbon nanostructure. Higher densities can desirably facilitate the processibility of the carbon nanostructure. The coating can be covalently bonded to the carbon nanotubes of the carbon nanostructure. In some embodiments, the carbon nanotubes can be functionalized before or after removal of the carbon nanostructure from the substrate so as to provide suitable reactive functional groups for forming such a coating. Suitable processes for functionalizing the carbon nanotubes of a carbon nanostructure are usually similar to those that can be used to functionalize individual carbon nanotubes and will be known by a person having ordinary skill in the art. In other embodiments, the coating can be non-covalently bonded to the carbon nanotubes of the carbon nanostructure. That is, in such embodiments, the coating can be physically disposed on the carbon nanotubes.

If desired, the coating on the carbon nanotubes can be a polymer coating. Suitable polymer coatings are not believed to be particularly limited and can include polymers such as, for example, an epoxy, polyester, vinylester polymer, polyetherimide, polyetherketoneketone, polyphthalamide, polyetherketone, polyetheretherketone, polyimide, phenol-formaldehyde polymer, bismaleimide polymer, acrylonitrile-butadiene styrene (ABS) polymer, polycarbonate, polyethyleneimine, polyurethane, polyvinyl chloride, polystyrene, polyolefin, polypropylene, polyethylene, polytetrafluoroethylene, and any combination thereof. In addition to polymer coatings, other types of coatings can also be present, such as metal coatings and ceramic coatings. Another additive material may also be present in at least the interstitial space between the carbon nanotubes of the carbon nanostructure (i.e., on the interior of the carbon nanostructure). The additive material can be used alone or in combination with a coating on the carbon nanotubes of the carbon nanostructure. When used in combination with a coating, the additive material can also be located on the exterior of the carbon nanostructure within the coating, in addition to being located within the interstitial space of the carbon nanostructure. Introduction of an additive material within the interstitial space of the carbon nanostructure or elsewhere within the carbon nanostructure can result in further modification of the properties of the carbon nanostructure. The nanostructures may also contain some transition metal nanoparticles employed as a catalyst during the synthesis of the nanostructures. The transition metal nanoparticles can be coated with an anti-adhesive coating that limits their adherence to a substrate or the carbon nanostructure to a substrate. In various embodiments, the anti-adhesive coating can be carried along with the transition metal nanoparticles as the carbon nanostructure and the transition metal nanoparticles are removed from the substrate. In other embodiments, the anti-adhesive coating can be removed from the transition metal nanoparticles before or after they are incorporated into the carbon nanostructure. In still other embodiments, the transition metal nanoparticles can initially be incorporated into the carbon nanostructure and then subsequently removed. For example, in some embodiments, at least a portion of the transition metal nanoparticles can be removed from the carbon nanostructure by treating the carbon nanostructure with a mineral acid. The nanostructures may also contain a substrate.

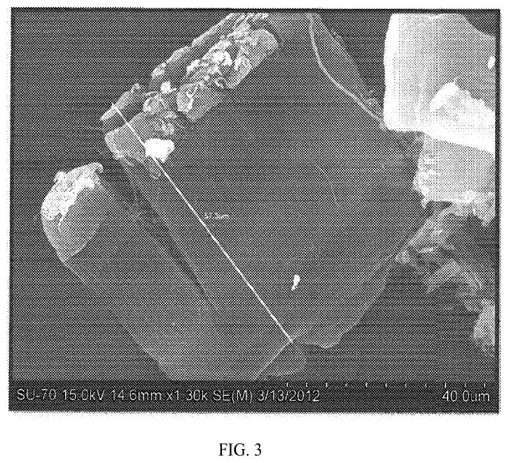

The carbon nanostructures may be provided in a variety of different forms, such as flakes, granules, pellets, fibers, or in other forms of loose particulate material. In certain embodiments, it may be desirable to employ carbon nanostructures that are in the form of a flake material, which includes discrete particles having finite dimensions. FIG. 2 shows an illustrative depiction of a carbon nanostructure flake material. A flake structure 100 can have a first dimension 110 that is in a range from about 1 nm to about 35 μm thick, particularly about 1 nm to about 500 nm thick, including any value in between and any fraction thereof. The flake structure 100 can have a second dimension 120 that is in a range from about 1 micron to about 750 microns tall, including any value in between and any fraction thereof. The flake structure 100 can have a third dimension 130 that is only limited in size based on the length of the substrate upon which the carbon nanostructure is initially formed. For example, in some embodiments, the process for growing a carbon nanostructure on a substrate can take place on a tow or roving of a fiber-based material of spoolable dimensions. The carbon nanostructure growth process can be continuous, and the carbon nanostructure can extend the entire length of a spool of fiber. Thus, in some embodiments, the third dimension 130 can be in a range from about 1 m to about 10,000 m wide. Again, the third dimension 130 can be very long because it represents the dimension that runs along the axis of the substrate upon which the carbon nanostructure is formed. The third dimension 130 can also be decreased to any desired length less than 1 μm. For example, in some embodiments, third dimension 130 can be on the order of about 1 μm to about 10 μm, or about 10 μm to about 100 μm, or about 100 μm to about 500 μm, or about 500 microns to about 1 cm, up to any desired length, including any amount between the recited ranges and any fractions thereof. Since the substrate upon which the carbon nanostructure is formed can be quite large, exceptionally high molecular weight carbon nanostructures can be produced by forming the polymer-like morphology of the carbon nanostructure as a continuous layer on a suitable substrate.

Referring still to FIG. 2, the flake structure 100 can include a webbed network of carbon nanotubes 140 in the form of a carbon nanotube polymer (i.e., a “carbon nanopolymer”) having a molecular weight in a range from about 15,000 g/mol to about 150,000 g/mol, including all values in between and any fraction thereof. In some embodiments, the upper end of the molecular weight range can be even higher, including about 200,000 g/mol, about 500,000 g/mol, or about 1,000,000 g/mol. The higher molecular weights can be associated with carbon nanostructures that are dimensionally long. In various embodiments, the molecular weight can also be a function of the predominant carbon nanotube diameter and number of carbon nanotube walls present within the carbon nanostructure. In some embodiments, the carbon nanostructure can have a crosslinking density ranging between about 2 mol/cm³ to about 80 mol/cm³. The crosslinking density can be a function of the carbon nanostructure growth density on the surface of the substrate as well as the carbon nanostructure growth conditions.

FIG. 3 shows an SEM image of an illustrative carbon nanostructure obtained as a flake material. The carbon nanostructure shown in FIG. 3 exists as a three dimensional microstructure due to the entanglement and crosslinking of its highly aligned carbon nanotubes. The aligned morphology is reflective of the formation of the carbon nanotubes on a substrate under rapid carbon nanotube growth conditions (e.g., several microns per second, such as about 2 microns per second to about 10 microns per second), thereby inducing substantially perpendicular carbon nanotube growth from the substrate. Without being bound by theory, it is believed that the rapid rate of carbon nanotube growth on the substrate can contribute, at least in part, to the complex, web-like structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the substrate to initiate carbon nanotube growth. The desired flake material may desirably be obtained after isolation of the carbon nanostructure from a substrate, such as described above.

As used herein, the “carbon nanotubes” employed in the nanostructures are generally any number of cylindrically-shaped allotropes of carbon of the fullerene family and include single-walled carbon nanotubes (SWNTs), double-walled carbon nanotubes (DWNTs), multi-walled carbon nanotubes (MWNTs), etc., as well as combinations thereof. The carbon nanotubes can be capped by a fullerene-like structure or open-ended, and may include those that encapsulate other materials. SWCNTs can be thought of as an allotrope of sp2-hybridized carbon similar to fullerenes. The structure is a cylindrical tube including six-membered carbon rings. Analogous MWCNTs, on the other hand, have several tubes in concentric cylinders. The number of these concentric walls may vary, such as from 2 to 25 or more. Typically, the diameter of MWNTs may be 10 nm or more, in comparison to 0.7 to 2.0 nm for typical SWNTs. It is typically desired that the carbon nanostructures employed in the polymer composition are formed from MWCNTs, such as those having at least two coaxial carbon nanotubes. The number of walls present, as determined, for example, by transmission electron microscopy (TEM), at a magnification sufficient for analyzing the number of wall in a particular case, can be within the range of from 2 to 30, in some embodiments, from 4 to 28, in some embodiments from 5 to 26, and in some embodiments, from 6 to 24. Carbon nanotubes present in or derived from the carbon nanostructures typically has a typical diameter of 100 nanometers or less, in some embodiments from about 5 to about 90 nanometers, and in some embodiments, from about 10 to about 30 nanometers. The carbon nanotubes may also have a length of about 2 micrometers or more, in some embodiments from about 2 to about 10 micrometers, and in some embodiments, from about 2.5 to about 5 micrometers. The aspect ratio of the carbon nanotubes may also be relatively high, such as from about 200 to about 1,000, in some embodiments from about 300 to about 900, and in some embodiments, from about 400 to about 800.

C. Other Components

As described above, the carbon nanostructures may be formed on a substrate that includes a fiber material, such as glass fibers, carbon fibers, etc. In certain embodiments, such carbon nanostructures may contain the only fiber material in the polymer composition, or at the very least, a substantial portion of fiber materials within the composition, such as more than about 50 wt. %, and in some embodiments, more than about 75 wt. % of fiber materials in the composition. Thus, for example, the polymer composition may be generally free of additional reinforcing fibers. Nevertheless, in certain instances, additional fibers may still be employed, albeit typically in a relatively low amount. For example, when employed, additional reinforcing fibers typically constitute no more than about 40 wt. % of the composition, in some embodiments no more than about 30 wt. % of the composition, and in some embodiments, from about 1 wt. % to about 25 wt. % the composition. Such reinforcing fibers may be formed from materials that are also generally insulative in nature, such as glass, ceramics (e.g., alumina or silica), aramids (e.g., Kevlar®), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof. The reinforcing fibers may be in the form of randomly distributed fibers, such as when such fibers are melt blended with the high performance polymer(s) during the formation of the polymer matrix. Regardless, the volume average length of the reinforcing fibers may be from about 1 to about 400 micrometers, in some embodiments from about 50 to about 400 micrometers, in some embodiments from about 80 to about 250 micrometers, in some embodiments from about 100 to about 200 micrometers, and in some embodiments, from about 110 to about 180 micrometers. The fibers may also have an average diameter of about 10 to about 35 micrometers, and in some embodiments, from about 15 to about 30 micrometers.

As also noted above, the carbon nanostructures contain electrically conductive carbon nanotubes optionally formed (e.g., infused) on a substrate which may itself be electrically conductive (e.g., carbon fibers). In certain embodiments, such carbon nanostructures may constitute the only electrically conductive material in the polymer composition, or at the very least, a substantial portion of electrically conductive materials within the composition such as more than about 50 wt. %, and in some embodiments, more than about 75 wt. % of electrically conductive materials in the composition. Thus, for example, the polymer composition may be generally free of additional electrically conductive materials. Nevertheless, in certain instances, additional electrically conductive materials may still be employed, albeit typically in a relatively low amount. For example, an additional electrically conductive carbon material may be employed that has a volume resistivity of less than about 1 ohm-cm, in some embodiments about less than about 0.1 ohm-cm, and in some embodiments, from about 1×10⁻⁸ to about 1×10⁻² ohm-cm, such as determined at a temperature of about 20° C. Suitable electrically conductive carbon materials may include, for instance, graphite, carbon black, carbon fibers, graphene, other types of carbon nanotubes, etc. Other suitable electrically conductive fillers may likewise include metals (e.g., metal particles, metal flakes, metal fibers, nano-diamonds, carbon black, etc.), ionic liquids, and so forth. When employed, for example, the electrically conductive filler may constitute from about 0.1 wt. % to about 10 wt. %, in some embodiments from about 0.2 wt. % to about 8 wt. %, and in some embodiments, from about 0.5 wt. % to about 6 wt. % of the polymer composition.

In certain embodiments, it may also be desirable to employ a dielectric filler in the polymer composition. When employed, the dielectric filler is typically present in an amount of from about 10 wt. % to about 60 wt. %, in some embodiments from about 20 wt. % to about 55 wt. %, and in some embodiments, from about 30 wt. % to about 50 wt. % of the composition. In certain embodiments, it may be desirable to selectively control the electrical properties of the dielectric filler to help achieve the desired results. For example, the dielectric constant of the material may be about 20 or more, ins some embodiments about 40 or more, and in some embodiments, about 50 more as determined at a frequency of 1 MHz. High dielectric constant materials may be employed in certain embodiments, such as from about 1,000 to about 15,000, in some embodiments from about 3,500 to about 12,000, and in some embodiments, from about 5,000 to about 10,000, as determined at a frequency of 1 MHz. In other embodiments, mid-range dielectric constant materials may be employed, such as from about 20 to about 200, in some embodiments from about 40 to about 150, and in some embodiments, from about 50 to about 100, as determined at a frequency of 1 MHz. The volume resistivity of the dielectric filler may likewise range from about 1×10¹¹ to about 1×10²⁰ ohm-cm, in some embodiments from about 1×10¹² to about 1×10¹⁹ ohm-cm, and in some embodiments, from about 1×10¹³ to about 1×10¹⁸ ohm-cm, such as determined at a temperature of about 20° C. in accordance with ASTM D257-14. The desired properties may be accomplished by selecting a single material having the target volume dielectric constant and/or volume resistivity, or by blending multiple materials together (e.g., insulative and electrically conductive) so that the resulting blend has the desired properties.

Particularly suitable inorganic oxide materials may include, for instance, ferroelectric and/or paraelectric materials. Examples of suitable ferroelectric materials include, for instance, barium titanate (BaTiO₃), strontium titanate (SrTiO₃), calcium titanate (CaTiO₃), magnesium titanate (MgTiO₃), strontium barium titanate (SrBaTiO₃), sodium barium niobate (NaBa₂Nb₅O₁₅), potassium barium niobate (KBa₂Nb₅O₁₅), calcium zirconate (CaZrO₃), titanite (CaTiSiO₅), as well as combinations thereof. Examples of suitable paraelectric materials likewise include, for instance, titanium dioxide (TiO₂), tantalum pentoxide (Ta₂O₅), hafnium dioxide (HfO₂), niobium pentoxide (Nb₂O₅), alumina (Al₂O₃), zinc oxide (ZnO), etc., as well as combinations thereof. Particularly suitable inorganic oxide materials are particles that include TiO₂, BaTiO₃, SrTiO₃, CaTiO₃, MgTiO₃, BaSrTi₂O₆, and ZnO. Of course, other types of inorganic oxide materials (e.g., mica) may also be employed as a dielectric filler.

In one particular embodiment, titanium dioxide (TiO₂) particles may be employed in the polymer composition as a dielectric filler. The particles may be in the rutile or anatase crystalline form, although rutile is particularly suitable due to its higher density and tint strength. Rutile titanium dioxide is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Preferably, the titanium dioxide particles may be in the rutile crystalline form and made using the chloride process. The titanium dioxide particles may be substantially pure titanium dioxide or may contain other metal oxides, such as silica, alumina, zirconia, etc. Other metal oxides may be incorporated into the particles, for example, by co-oxidizing or co-precipitating titanium compounds with other metal compounds, such as metal halides of silicon, aluminum and zirconium. If co-oxidized or co-precipitated metals are present, they are typically present in an amount 0.1 to 5 wt. % as the metal oxide based on the weight of the titanium dioxide particles. When alumina is incorporated into the particles by co-oxidation of aluminum halide (e.g., aluminum chloride), alumina is typically present in an amount from about 0.5 to about 5 wt. %, and in some embodiments, from about 0.5 to about 1.5 wt. % based on the total weight of the particles. The titanium dioxide particles may also be coated with an inorganic oxide (e.g., alumina), organic compound, or a combination thereof. Such coatings may be applied using a surface wet treatment technique and/or oxidation technique as are known by those skilled in the art. In one embodiment, for example, the titanium dioxide particles may contain a coating that includes alumina, such as in an amount of from about 0.5 to about 5 wt. %, and in some embodiments, from about 1 to about 3 wt. % of the coating.

The shape and size of the dielectric fillers are not particularly limited and may include particles, fine powders, fibers, whiskers, tetrapod, plates, etc. In one embodiment, for instance, the dielectric filler may include particles having an average diameter of from about 0.01 to about 50 micrometers, in some embodiments from about 0.05 to about 10 micrometers, and in some embodiments, from about 0.1 to about 1 micrometer.

Another suitable dielectric filler may include a polyhedral silsesquioxane (“POSS”). Polyhedral silsesquioxanes have the generic formula (RSiO_{1.5})ₙ wherein R is an organic moiety and n is 6, 8, 10, 12, or higher. These molecules have rigid, thermally stable silicon-oxygen frameworks with an oxygen to silicon ratio of 1.5. One particular example of an Si₈ POSS structure is illustrated below:

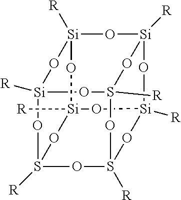

Functionalized POSS monomers may also be employed, such as by corner-capping an incompletely condensed POSS containing trisilanol groups with a substituted trichlorosilane. For example, the trisilanol functionality of R₇T₄D₃(OH)₃ (wherein R is a hydrocarbon group) can be reacted with Cl₃Si—Y to produce the fully condensed POSS monomer R₇T₈Y. In the following structure, T is SiO_{1.5}, and Y is an organic group comprising a functional group:

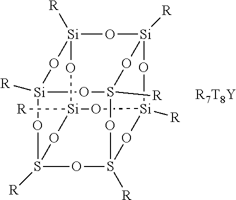

Through variation of the Y group on the silane, a variety of functional groups can be placed off the corner of the POSS framework, including but not limited to halide, alcohol, amine, hydride, isocyanate, acid, acid chloride, silanols, silane, acrylate, methacrylate, olefin, and epoxide.

Further examples of suitable POSS monomers include those of the general formula Rₙ₋ₘTₙYₘ wherein R is a hydrocarbon; n is 6, 8, 10, 12 or higher; m is 1 to n; T is SiO_{1.5}, and Y is an organic group comprising a functional group, wherein the functional group includes, for example, halide, alcohol, amine, isocyanate, acid, acid chloride, silanols, silane, acrylate, methacrylate, olefin, and epoxide. A suitable POSS monomer has, for example, an n of 8; m of 1, 2, 3, 4, 5, 6, 7, or 8; R of C₁-C₂₄ straight, branched, or cyclic alkyl, C₁-C₂₄ aromatic, alkylaryl, or arylakyl, wherein the alkyl, or aromatic is optionally substituted with C₁-C₆ alkyl, halo, C₁-C₆ alkoxy, C₁-C₆ perhaloalkyl, and so forth. Another suitable POSS monomer includes those of the general formula R₇T₄D₃(OY)₃:

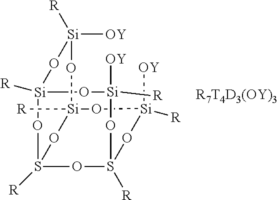

wherein R and Y are as defined previously for the R₇T₈Y POSS monomer.

Suitable functional groups are epoxies, esters and acrylate (—X—OC(O)CH═CH₂) and methacrylate (—X—OC(O)CH(CH₃)═CH₂) groups, wherein X is a divalent linking group having 1 to about 36 carbons, such as methylene, ethylene, propylene, isopropylene, butylene, isobutylene, phenylene, and the like. X may also be substituted with functional groups such as ether (e.g., —CH₂CH₂OCH₂CH₂—), as long as such functional groups do not interfere with formation or use of the POSS. X may be propylene, isobutylene, or —OSi(CH₃)₂CH₂CH₂CH₂—. One, all, or an intermediate number of the covalently bound groups may be acrylate or methacrylate groups (hereinafter (meth)acrylate). The linking groups X are suitable for use with other functional groups. Other POSS structures include, for example T₆, T₈, T₁₀, or T₁₂ structures functionalized with alkoxysilanes such as diethoxymethylsilylethyl, diethoxymethylsilylpropyl, ethoxydimethylsilylethyl, ethoxydimethylsilylpropyl, triethoxysilylethyl, etc.; with styrene, such as styrenyl (—C₆H₅CH═CH—), styryl (—C₆H₄CH═CH₂), etc.; with olefins such as allyl, —OSi(CH₃)₂CH₂CH═CH₂, cyclohexenylethyl, —OSi(CH₃)₂CH═CH₂, etc., with epoxies, such as 4-propyl-1,2-epoxycyclohexyl, 3-propoxy, glycidyl, etc., with chlorosilanes such as chlorosilylethyl, dichlorosilylethyl, trichlorosilylethyl, and the like; with amines such as aminopropyl, aminoethylaminopropyl, and the like; with alcohols and phenols such as —OSi(CH₃)₂CH₂CH₂CH₂OC(CH₂CH₃)₂(CH₂CH₂OH), 4-propylene-trans-1,2-cyclohexanediol, etc.; with phosphines such as diphenylphosphinoethyl, diphenylphosphinopropyl, etc.; with norbornenyls such as norbornenylethyl; with nitriles such as cyanoethyl, cyanopropyl, —OSi(CH₃)₂CH₂CH₂CH₂CN, etc.; with isocyanates such as isocyanatopropyl, —OSi(CH₃)₂CH₂CH₂CH₂NCO, etc., with halides such as 3-chloropropyl, chlorobenzyl (—C₆H₄CH₂Cl), chlorobenzylethyl, 4-chlorophenyl, trifluoropropyl (including a T₈ cube with eight trifluoropropyl substitutions), etc.; and with esters, such as ethyl undecanoat-1-yl and methyl propionat-1-yl, etc.

Of course, various other optional components may also be employed within the polymer composition, such as thermally conductive fillers, impact modifiers, compatibilizers, particulate fillers (e.g., talc, mica, etc.), stabilizers (e.g., antioxidants, UV stabilizers, etc.), flame retardants, lubricants, colorants, flow modifiers, pigments, and other materials added to enhance properties and processability. Suitable thermally conductive fillers may include, for instance, carbon black, alumina, boron nitride, silica, carbon fibers, graphene, graphene oxide, graphite (e.g., expanded graphite, synthesized graphite, low-temperature expanded graphite, and the like), aluminum nitride, silicon nitride, metal oxide (such as, for example, zinc oxide, magnesium oxide, beryllium oxide, titanium oxide, zirconium oxide, yttrium oxide, and the like), nano-diamonds, carbon nanotubes, which may be the same or different than those described above, calcium carbonate, talc, mica, wollastonite, clays (including exfoliated clays), metal powders (such as, for example, aluminum, copper, bronze, brass, and the like), or mixtures thereof. In certain embodiments, for example, the thermally conductive filler may include carbon fibers.

Flow modifiers may also be employed to help achieve the desired melt viscosity for the composition, particularly when thermoplastic polymers having a higher intrinsic viscosity (e.g., polyaryletherketones, liquid crystalline polymers, etc.) are employed. When employed, such flow modifiers are typically present in an amount of from about 0.05 to about 5 parts, in some embodiments from about 0.1 to about 1 part, and in some embodiments, from about 0.2 to about 1 part by weight relative to 100 parts by weight of the liquid crystalline polymer(s). For example, the flow modifier may constitute from about 0.01 wt. % to about 5 wt. %, in some embodiments from about 0.05 wt. % to about 3 wt. %, and in some embodiments, from about 0.1 wt. % to about 1 wt. % of the polymer composition.

If desired, the thermoplastic polymer(s) may be melt processed in the presence of the flow modifier to help achieve the desired low melt viscosity without sacrificing other properties of the composition. In such instances, the flow modifier may be a compound that contains one or more functional groups (e.g., hydroxyl, carboxyl, etc.). The term “functional” generally means that the compound contains at least one functional group (e.g., carboxyl, hydroxyl, etc.) or is capable of possessing such a functional group in the presence of a solvent. The functional compounds used herein may be mono-, di-, tri-functional, etc. The total molecular weight of the compound is relatively low so that it so that it can effectively serve as a flow modifier for the polymer composition. The compound typically has a molecular weight of from about 2,000 grams per mole or less, in some embodiments from about 25 to about 1,000 grams per mole, in some embodiments from about 50 to about 500 grams per mole, and in some embodiments, from about 100 to about 400 grams per mole. Any of a variety of functional compounds may generally be employed. In certain embodiments, a metal hydroxide compound may be employed that has the general formula M(OH)ₛ, where s is the oxidation state (typically from 1 to 3) and M is a metal, such as a transitional metal, alkali metal, alkaline earth metal, or main group metal. Without intending to be limited by theory, it is believed that such compounds can effectively “lose” water under the process conditions (e.g., high temperature), which can assist in melt viscosity reduction. Examples of suitable metal hydroxides may include copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. Also suitable are metal alkoxide compounds that are capable of forming a hydroxyl functional group in the presence of a solvent, such as water. Such compounds may have the general formula M(OR)ₛ, wherein s is the oxidation state (typically from 1 to 3), M is a metal, and R is alkyl. Examples of such metal alkoxides may include copper (II) ethoxide (Cu²⁺(CH₃CH₂O⁻)₂), potassium ethoxide (K⁺(CH₃CH₂O⁻)), sodium ethoxide (Na⁺(CH₃CH₂O⁻)), magnesium ethoxide (Mg²⁺(CH₃CH₂O⁻)₂), calcium ethoxide (Ca²⁺(CH₃CH₂O⁻)₂), etc.; aluminum ethoxide (Al³⁺(CH₃CH₂O⁻)₃), and so forth. Besides metal hydroxides, metal salt hydrates may also be employed, which are typically represented by the formula MA*xH₂O, wherein M is a metal cation, A is an anion, and x is from 1 to 20, and in some embodiments, from 2 to 10. Specific examples of such hydrates may include, for instance, CaCl₂·H₂O, ZnCl₂·4H₂O, CoCl₂·6H₂O, CaSO₄·2H₂O, MgSO₄·7H₂O, CuSO₄·5H₂O, Na₂SO₄·10H₂O, Na₂CO₃·10H₂O, Na₂B₄O₇·10H₂O and Ba(OH)₂·8H₂O.

### II. Formation

Regardless of the ingredients employed, the carbon nanostructures and other optional components may be melt processed or blended together with the thermoplastic polymer(s) in the composition. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

### III. Parts

As indicated above, the polymer composition may be employed in a wide variety of parts of an electronic device. Such parts may be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

### IV. Electronic Device

The polymer composition and parts formed therefrom may be employed in a wide variety of electronic devices depending on the particular properties desired. In one embodiment, for example, the polymer composition may be employed in an electronic device to help impart EMI shielding. In one such embodiment, the electronic device may contain a housing that receives one or more electronic components (e.g., printed circuit board, antenna elements, radio frequency sensing elements, sensors, light sensing and/or transmitting elements (e.g., fibers optics), cameras, global positioning devices, etc.). The housing may, for instance, include a base that contains a sidewall extending therefrom. A cover may also be supported on the sidewall of the base to define an interior within which the electronic component(s) are received and protected from the exterior environment. Regardless of the particular configuration of the device, the polymer composition may be used to form all or a portion of the housing and/or cover. In one embodiment, for instance, the polymer composition may be used to form the base and sidewall of the housing. The cover may be formed from the polymer composition or from a different material. In this regard, conventional EMI metal shields (e.g., aluminum plates) can be eliminated from the device design, thereby reducing the weight and overall cost of the device. Nevertheless, in certain other embodiments, such additional shields may be employed. For example, the cover may contain an additional metal component (e.g., aluminum plate) in some cases.

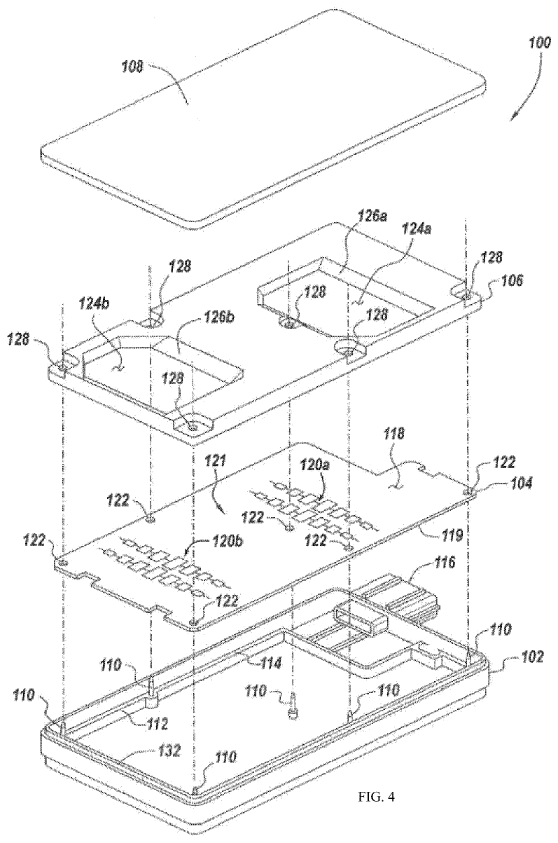

Referring to FIG. 4, for instance, one particular embodiment of an electronic device 100 is shown that may incorporate the polymer composition of the present invention. The electronic device 100 includes a housing 102 that contains sidewalls 132 extending from a base 114. If desired, the housing 102 may also contain a shroud 116 that can accommodate an electrical connector (not shown). Regardless, a printed circuit board (“PCB”) is received within the interior of the device 100 and attached to housing 102. More particularly, the circuit board 104 contains holes 122 that are aligned with and receive posts 110 located on the housing 102. The circuit board 104 has a first surface 118 on which electrical circuitry 121 is provided to enable radio frequency operation of the device 100. For example, the RF circuitry 121 can include one or more antenna elements 120a and 120b. The circuit board 104 also has a second surface 119 that opposes the first surface 118 and may optionally contain other electrical components, such as components that enable the digital electronic operation of the device 100 (e.g., digital signal processors, semiconductor memories, input/output interface devices, etc.). Alternatively, such components may be provided on an additional printed circuit board. A cover 108 may also be employed that is disposed over the circuit board 104 and attached to the housing 102 (e.g., sidewall) through known techniques, such as by welding, adhesives, etc., to seal the electrical components within the interior. As indicated above, the polymer composition of the present invention may be used to form all or a portion of the cover 108 and/or the housing 102. As noted above, because it possesses EMI shielding effectiveness, conventional EMI shields (e.g., aluminum plates) may be eliminated.

The EMI-shielded electronic device may be used in a wide variety of applications. For example, the electronic device may be employed in an automotive vehicle (e.g., electric vehicle). When used in automotive applications, for instance, the electronic device may be used to sense the positioning of the vehicle relative to one or more three-dimensional objects. In this regard, the device may contain radio frequency sensing components, light detection or optical components, cameras, antenna elements, etc., as well as combinations thereof. For example, the device may be a radio detection and ranging (“radar”) device, light detection and ranging (“lidar”) device, camera module, global positioning module, etc., or it may be an integrated device that combines two or more of these components. Such devices may thus employ a housing that receives one or more types of electronic components (e.g., printed circuit board, antenna elements, radio frequency sensing devices, sensors, light sensing and/or transmitting elements (e.g., fibers optics), cameras, global positioning devices, etc.). In one embodiment, for example, a lidar device may be formed that contains a fiber optic assembly for receiving and transmitting light pulses that is received within the interior of a housing/cover assembly in a manner similar to the embodiments discussed above. Similarly, a radar device typically contains one or more printed circuit boards having electrical components dedicated to handling radio frequency (RF) radar signals, digital signal processing tasks, etc.

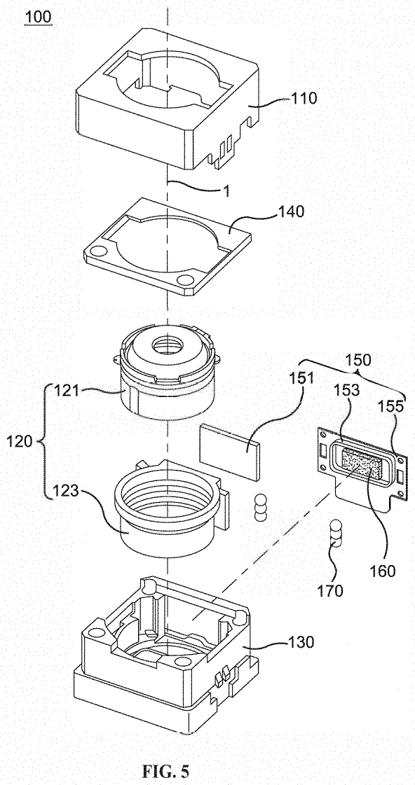

As indicated above, the polymer composition of the present invention may also be well suited to impart electrostatic discharge properties to components of the device, such as in a camera module. A camera module, for instance, typically includes a housing which which a lens module is positioned that contains one or more lenses. Referring to FIG. 5, for example, one embodiment of a camera module 100 is shown that contains a lens module 120 that is contained within a housing, wherein the lens module 120 contains a lens barrel 121 coupled to a lens holder 123. The lens barrel 121 may have a hollow generally cylindrical shape so that one or more lenses for imaging an object may be received therein in an optical axis direction 1. The lens barrel 121 may be inserted into a hollow cavity provided in the lens holder 123, which may also be generally cylindrical, and the lens barrel 121 and the lens holder 123 may be coupled to each other by a fastener (e.g., screw), adhesive, etc. The lens module 120, including the lens barrel 121, may be moveable in in the optical axis direction 1 (e.g., for auto-focusing) by an actuator assembly 150. In the illustrated embodiment, for example, the actuator assembly 150 may include a magnetic body 151 and a coil 153 configured to move the lens module 120 in the optical axis direction 1. The magnetic body 151 may be mounted on one side of the lens holder 123, and the coil 153 may be disposed to face the magnetic body 151. The coil 153 may be mounted on a substrate 155, which is in turn may be mounted to the housing 130 so that the coil 153 faces the magnetic body 151. The actuator assembly 150 may include a drive device 160 that is mounted on the substrate 155 and that outputs a signal (e.g., current) for driving the actuator assembly 150 depending on a control input signal. The actuator assembly 150 may receive the signal and generate a driving force that moves the lens module 120 in the optical axis direction 1. If desired, a stopper 140 may also be mounted on the housing 130 to limit a moving distance of the lens module 120 in the optical axis direction 1. Further, a shield case 110 may also be coupled to the housing 130 to enclose outer surfaces of the housing 130, and thus block electromagnetic waves generated during driving of the camera module 100.

The actuator assembly may also include a guide unit that is positioned between the housing and the lens module to help guide the movement of the lens module. Any of a variety of guide units may be employed as known in the art, such as spring(s), ball bearing(s), electrostatic force generators, hydraulic force generators, etc. For example, springs can be employed that generate a preload force that acts on the lens module and guides it into the desired optical axis direction. Alternatively, as illustrated in the embodiment shown in FIG. 1, ball bearings 170 may act as a guide unit of the actuator assembly 150. More specifically, the ball bearings 170 may contact an outer surface of the lens holder 123 and an inner surface of the housing 130 to guide the movement of the lens module 120 in the optical axis direction 1. That is, the ball bearings 170 may be disposed between the lens holder 123 and the housing 130, and may guide the movement of the lens module 120 in the optical axis direction through a rolling motion. Any number of ball bearings 170 may generally be employed for this purpose, such as 2 or more, in some embodiments from 3 to 20, and in some embodiments, from 4 to 12. The ball bearings 170 may be spaced part or in contact with each other, and may also be stacked in a direction perpendicular to the optical axis direction 1. The size of the ball bearings 170 may vary as is known to those skilled in the art. For instance, the ball bearings may have an average size (e.g., diameter) of about 800 micrometers or less, in some embodiments about 600 micrometers or less, in some embodiments about 400 micrometers or less, and in some embodiments, from about 50 to about 200 micrometers.

The polymer composition of the present invention may be employed in any of a variety of parts of the camera module. Referring again to FIG. 5, for instance, the polymer composition may be used to form all or a portion of the actuator assembly 150 (e.g., magnetic body 151, ball bearings 170, etc.), housing 130, lens barrel 121, lens holder 123, substrate 155, stopper 140, shield case 110, and/or any other portion of the camera module. For example, it may be particularly desirable to employ the composition in the magnetic body 151, lens barrel 121, and/or the lens holder 123 to help minimize optical misalignment.

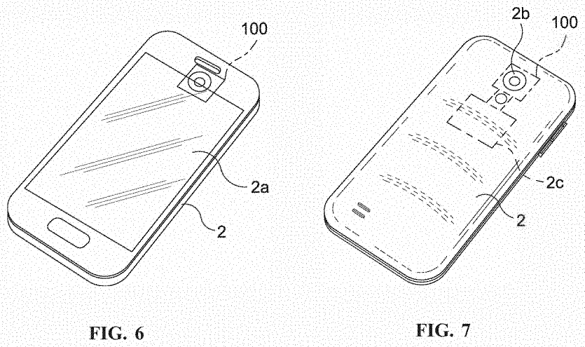

The resulting camera module may be used in a wide variety of electronic devices as is known in the art, such as in portable electronic devices (e.g., mobile phones, portable computers, tablets, watches, etc.), computers, televisions, automotive parts, etc. In one particular embodiment, the polymer composition may be employed in a camera module, such as those commonly employed in wireless communication devices (e.g., cellular telephone). Referring to FIGS. 6-7, for example, one embodiment of an electronic device 2 (e.g., phone) is shown that includes a camera module 100. As illustrated, a lens of the camera module 100 may be exposed to the outside of the electronic device 2 through an opening 2b to image an external object. The camera module 100 may also be electrically connected to an application integrated circuit 2c to perform a control operation depending on selection of a user.

The present invention may be better understood with reference to the following examples.

### Test Methods

Surface/Volume Resistivity: The surface and volume resistivity values are generally determined in accordance with IEC 62631-3-2-2016 and IEC 62631-3-1-1:2016, respectively, (equivalent to ASTM D257-14). According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density. In SI units, volume resistivity is numerically equal to the direct-current resistance between opposite faces of a one-meter cube of the material (ohm-m).

Electromagnetic Interference (“EMI”) Shielding: EMI shielding effectiveness may be determined in accordance with ASTM D4935-18 at frequency ranges ranging from 700 MHz to 18 GHz (e.g., 5 GHz). The thickness of the parts tested may vary, such as 1 millimeter, 1.6 millimeters, or 3 millimeters. The test may be performed using an EM-2108 standard test fixture, which is an enlarged section of coaxial transmission line and available from various manufacturers, such as Electro-Metrics. The measured data relates to the shielding effectiveness due to a plane wave (far field EM wave) from which near field values for magnetic and electric fields may be inferred.

Tensile Modulus, Tensile Stress, and Tensile Elongation at Break: Tensile properties may be tested according to ISO 527-1:2019 (technically equivalent to ASTM D638-14). Modulus and strength measurements may be made on a dogbone-shaped test strip sample having a length of 170/190 mm, thickness of 4 mm, and width of 10 mm. The testing temperature may be −30° C., 23° C., or 80° C. and the testing speeds may be 1 or 5 mm/min.

Flexural Modulus, Flexural Elongation at Break, and Flexural Stress: Flexural properties may be tested according to ISO 178:2019 (technically equivalent to ASTM D790-17). This test may be performed on a 64 mm support span. Tests may be run on the center portions of uncut ISO 3167 multi-purpose bars. The testing temperature may be −30° C., 23° C., or 80° C. and the testing speed may be 2 mm/min.

Charpy Impact Strength: Charpy properties may be tested according to ISO 179-1:2010) (technically equivalent to ASTM D6110). This test may be run using a Type 1 specimen size (length of 80 mm, width of 10 mm, and thickness of 4 mm). Specimens may be cut from the center of a multi-purpose bar using a single tooth milling machine. The testing temperature may be −30° C., 23° C., or 80° C.

Deflection Temperature Under Load (“DTUL”): The deflection under load temperature may be determined in accordance with ISO 75-1,-2:2013 (technically equivalent to ASTM D648-07). More particularly, a test strip sample having a length of 80 mm, width of 10 mm, and thickness of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-2:2020. Under the DSC procedure, samples were heated and cooled at 20° C. per minute as stated in ISO Standard 10350 using DSC measurements conducted on a TA Q2000 Instrument.

Melt Viscosity: The melt viscosity (Pa-s) may be determined in accordance with ISO Test No. 11443:2021 at a shear rate of 1,000 s⁻¹ and temperature 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

### Examples 1-4

Examples 1-4 are formed from various combinations of a liquid crystalline polymer (LCP 1 and/or LCP 2), glass fibers, aluminum trihydrate (“ATH”), titanium dioxide particles (chloride-process rutile containing alumina and hydrophobic organic surface treatment, average particle size of 0.27 μm), carbon fibers, and carbon nanostructures. LCP 1 is formed from 43% HBA, 9% TA, 29% HQ, and 20% NDA. LCP 2 is formed from 78% HBA and 27% HNA. Compounding was performed using a 32-mm single screw extruder. The components of each Example are set forth in more detail below.

| | 1 | 2 | 3 | 4 |
|---|---|---|---|---|
| LCP 1 | 40.5 | 40.5 | — | 50 |
| LCP 2 | 4.6 | 8.2 | 90 | 45 |
| Glass Fibers | 20 | 20 | — | — |
| ATH | 0.5 | 0.5 | — | — |
| Titanium Dioxide | 35 | 35 | — | — |
| Carbon Fibers | 1.2 | 1.2 | — | — |
| Carbon Nanostructures | 0.2 | 0.6 | 10 | 5 |

Examples 1-4 were tested for mechanical properties, thermal properties, and electrical properties as described herein. The results are set forth below.

| | 1 | 2 | 3 | 4 |
|---|---|---|---|---|
| Surface Resistivity (ohm) | 5.40E+11 | 7.10E+05 | 6.00E+04 | 1.60E+05 |
| Volume Resistivity | 5.50E+06 | 3.50E+03 | 1.50E+03 | 1.30E+03 |
| (ohm-m) | | | | |
| DTUL (1.8 MPa) (° C.) | 277 | 272 | — | — |
| Charpy Notched (kJ/m²) | 16 | 15 | — | — |
| Charpy Unnotched | 16.4 | 14.2 | — | — |
| (kJ/m²) | | | | |
| Tensile Strength (MPa) | 126 | 121 | — | — |
| Tensile Modulus (MPa) | 17815 | 18635 | — | — |
| Tensile Elongation (%) | 0.98 | 0.84 | — | — |
| Flexural Strength (MPa) | 185 | 178 | — | — |
| Flexural Modulus (MPa) | 17250 | 18313 | — | — |
| Flexural Elongation (%) | 1.38 | 1.21 | — | — |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition that includes carbon nanostructures dispersed within a polymer matrix that contains a thermoplastic polymer having a deflection temperature under load of about 40° C. or more as determined in accordance with ISO 75:2013 at a load of 1.8 MPa and a melting temperature of about 140° C. or more, wherein the carbon nanostructures include carbon nanotubes that are arranged in a network having a web-like morphology and optionally disposed on a substrate.

2. The polymer composition of claim 1, wherein the composition exhibits a surface resistivity of about 1×10¹² ohms or less as determined at a temperature of about 20° C. in accordance with IEC 62631-3-2:2016.

3. The polymer composition of claim 1, wherein the composition exhibits a volume resistivity of about 1×10⁷ ohm-m or less as determined at a temperature of about 20° C. in accordance with IEC 62631-3-1:2016.

4. The polymer composition of claim 1, wherein the thermoplastic polymer has a deflection temperature under load of about 150° C. or more as determined in accordance with ISO 75:2013 at a load of 1.8 MPa.

5. The polymer composition of claim 1, wherein the thermoplastic polymer includes an aromatic polymer.

6. The polymer composition of claim 5, wherein the aromatic polymer includes a thermotropic liquid crystalline polymer.

7. The polymer composition of claim 6, wherein the thermotropic liquid crystalline polymer contains repeating units derived from one or more aromatic dicarboxylic acids, one or more aromatic hydroxycarboxylic acids, or a combination thereof.

8. The polymer composition of claim 7, wherein the aromatic hydroxycarboxylic acids include 4-hydroxybenzoic acid, 6-hydroxy-2-naphthoic acid, or a combination thereof.

9. The polymer composition of claim 7, wherein the aromatic dicarboxylic acids include terephthalic acid, isophthalic acid, 2,6-naphthalenedicarboxylic acid, or a combination thereof.

10. The polymer composition of claim 7, wherein the thermotropic liquid crystalline polymer further contains repeating units derived from one or more aromatic diols.

11. The polymer composition of claim 10, wherein the aromatic diols include hydroquinone, 4,4′-biphenol, or a combination thereof.

12. The polymer composition of claim 7, wherein the thermotropic liquid crystalline polymer is wholly aromatic.

13. The polymer composition of claim 7, wherein the thermotropic liquid crystalline polymer includes repeating units derived from naphthenic hydroxycarboxylic and/or dicarboxylic acids in an amount of about 10 mol. % or more.

14. The polymer composition of claim 1, wherein the thermoplastic polymer includes a polyarylene sulfide.

15. The polymer composition of claim 1, wherein the thermoplastic polymer includes a polyaryletherketone.

16. The polymer composition of claim 1, wherein the carbon nanostructures are present in an amount of from about 0.1 parts to about 10 parts by weight per 100 parts by weight of the polymer matrix.

17. The polymer composition of claim 1, wherein the carbon nanostructures are in the form of a flake material.

18. The polymer composition of claim 1, wherein the carbon nanostructures include a substrate on which the carbon nanotubes are infused.

19. The polymer composition of claim 18, wherein the substrate includes a fiber material.

20. The polymer composition of claim 19, wherein the fiber material includes carbon fibers, glass fibers, or a combination thereof.

21. The polymer composition of claim 1, wherein the polymer composition contains an electrically conductive filler.

22. The polymer composition of claim 1, wherein the polymer composition contains reinforcing fibers.

23. The polymer composition of claim 1, wherein the polymer composition contains a dielectric filler.

24. The polymer composition of claim 23, wherein the dielectric filler includes a polyhedral silsesquioxane.

25. An electronic device comprising a housing, at least one electronic component mounted in the housing, and a shield mounted over a first side of the electronic component, wherein the shield and/or the housing comprise the polymer composition of claim 1.

26. The electronic device of claim 25, wherein the electronic component includes an antenna element.

27. The electronic device of claim 25, wherein the electronic device is a radar device.

28. The electronic device of claim 27, further comprising a radome mounted over the shield.

29. A camera module comprising a housing within which a lens module is positioned that contains one or more lenses, wherein the camera module comprises the polymer composition of claim 1.

30. The camera module of claim 29, wherein at least a portion of the housing, lens module, or a combination thereof contains the polymer composition.

31. The camera module of claim 29, wherein the lens module contains a lens barrel coupled to a lens holder.

32. The camera module of claim 31, wherein at least a portion of the lens holder, the lens barrel, or a combination thereof, contains the polymer composition.

33. The camera module of claim 31, wherein the lens barrel receives the one or more lenses.
